(19) United States
(12) Patent Application Publication
(10) Pub. No.: US 2011/0256200 A1
(43) Pub. Date: Oct. 20, 2011

(54) PROCESS AND AQUEOUS FORMULATION FOR THE IMPREGNATION OF NON-LIVING-MATERIALS IMPARTING A PROTECTIVE ACTIVITY AGAINST PESTS

(75) Inventors: Michael Ishaque, Mannheim (DE); Arnold Kraushaar, Sinsheim (DE); Egon Weinmueller, Limburgerhof (DE)

(73) Assignee: BASF SE, LUDWIGSHAFEN (DE)

(21) Appl. No.: 13/140,960

(22) PCT Filed: Dec. 21, 2009
(86) PCT No.: PCT/EP09/67663

§ 371 Date: Jun. 20, 2011

(30) Foreign Application Priority Data
Dec. 23, 2008 (EP) 08172876.8

(51) Int. Cl. A01N 25/34; A01P 7/04; A01N 37/34

(52) U.S. Cl. 424/411; 514/521

(57) ABSTRACT

A process for the impregnation of non-living-materials comprises the step of impregnating the non-living material with an aqueous formulation free of organic solvents which comprises one or more pesticides and a polymeric binder comprising one or more fluorinated polyacrylates having a fluorine content (based on the solid content of the polymeric binder) of at least 10% by weight.

The invention relates to a process for impregnating non-living, preferably textile materials, an aqueous formulation for the impregnation of such materials, comprising at least a pesticide and a polymeric binder comprising a fluorinated polyacrylate and the use of such impregnated materials as mosquito-nets and for the protection of plants and other goods.

In tropical countries infectious diseases are frequently transmitted by biting or blood-feeding insects. Besides medical methods like vaccination efforts have been concentrated on methods of controlling such transmitting insects. Methods of controlling such insects comprise treating surfaces of huts and houses, air spraying and impregnation of curtains and bednets. The latter may be done by dipping the textile material into emulsions or dispersions of insecticides or spraying insecticides onto the nets. Since such a treatment provides only a poor adhesion of the insecticide molecules on the surface of the textile materials the treatment is not wash-permanent and has to be repeated after every washing.

For that reason, efforts have been concentrated on the long-term fixation of such insecticides on textile materials using certain binders and/or other auxiliaries in order to obtain textile materials which need not to be treated again after every washing but retain its activity on long term.

WO 92/16103 discloses active ingredient containing liquid formulations wherein the active ingredient is made water and oil resistant after application thereof to a substrate by the addition to the formulation of a fluorinated acrylic polymer. The substrate can be either an animate or inanimate object. Active ingredients include repellents, attractants, pesticides, growth regulators, sunscreen agents, or medicines. The liquid formulations can be aqueous or organic solvent based or a mixture thereof. A possible wash fastness of the coated substrate is not contemplated in this document.

WO 01/37662 discloses impregnated nettings or fabrics for insect or tick killing and/or repellent of an insect or tick comprising an insecticide and/or a repellent, and a film forming component reducing the wash off and degradation of the insecticide component from the netting or fabric by forming a water- and optionally an oil-resistant film. The film forming component comprises one or more components selected from paraffin oil or wax derivatives, silicon derivatives, silicon oils or wax derivatives, and polyfluorocarbon derivatives. Organic solvents are employed in the impregnation process.

WO 2006/128870 discloses a composition for the impregnation of non-living, in particular textile materials, which comprises an N-arylhydrazine derivative and at least one polymeric binder. The binder may be selected from—inter alia—fluorocarbon resins but no impregnation process involving fluorocarbon resins is given.

WO 2007/085640 discloses an impregnated insecticide containing textile that after several washes comprises insecticide on the surface of the textile, characterised by that at least 50% of the insecticide is present as solid from micro particles in the textile and wherein at least 75% of the solid form micro particles in the textile are solid form micro particles with a particle size from 0.1 to 25 μm and wherein the solid form micro particles are solid form micro particles comprising micro-crystal particles of insecticide (for example as micro-crystal particles of insecticide coated with resin. Fluorocarbon resins are used as binders and organic solvents are used in the impregnation process.

Further disclosed is an impregnated textile comprising a “two layer” coating, wherein one first layer surrounds the insecticide there is present on the textile fibres and in this first layer the insecticide have a relatively low solubility, and a second layer is built on top of the first layer and this second layer shall have a much lower solubility for the insecticide as compared to the solubility in the first layer, wherein the material for the first coating is a resin such as a synthetic resin (e.g. based on polyacrylate or polyvinyl) and wherein there is preferably made a relatively thick layer of resin in order for the first coating layer to have a relatively big “reservoir” capacity, and wherein the material for the second coating is a polymer selected from the group consisting of fluorocarbon polymer, polyurethanes, polyacrylics, poly-isocyanates and polylactic acids. Again, organic solvents are employed in the impregnation process.

WO 2008/122287 relates to a process—as disclosed in WO 01/37662 for the impregnation of a non living material, for example a fabric or a netting, so as to impart insect killing and/or repellence properties. The process involves the preparation of a solution of an insecticide and a film forming component reducing wash off and degradation of the insecticide, wherein said film forming component comprises a polymeric backbone fixative polymerizing into a film with polyfluorocarbon side chains on the polymeric backbone in a drying and curing process of the non-living material. The risk for precipitation of the insecticide in the solution of the insecticide is reduced if the insecticide is dissolved in a solvent combined with alcohol or glycol having a water content of less than 5%, and/or the insecticide is dissolved in a solvent and mixed with a water phase emulsion or solution having a temperature of less than 30° C.

It is an object of the present invention to provide a method for impregnating textile materials with pesticides which may be performed at ambient temperatures and which nevertheless yields a textile material in which the pesticide activity is maintained even after multiple washes. It is a further object of the invention to provide an economical and ecological method for impregnating textile materials that is not hazardous to workers in the production process or end users carrying out the impregnation before the first use. Furthermore, it is an object of the invention to provide formulations suitable for use in said impregnation process.

It has been found that these objects can be achieved by an impregnation process using an aqueous formulation free of organic solvents and comprising at least one insecticide and a fluorinated polyacrylate with a fluorine content of at least 10% by weight as a binder.

In a first aspect of the invention, there is provided a process for manufacturing a pesticide treated non-living material, comprising the step of impregnating the non-living material with an aqueous formulation free of organic solvents which comprises one or more pesticides and a polymeric binder comprising one or more fluorinated polyacrylates having a fluorine content (based on the solid content of the polymeric binder) of at least 10% by weight.

In a second aspect of the invention, there is a provided an aqueous impregnation formulation free of organic solvents and comprising one or more pesticides and a polymeric binder comprising one or more fluorinated polyacrylates having a fluorine content (based on the solid content of the polymeric binder) of at least 10% by weight.

In a third aspect of the invention, there is provided the use of the above formulation for impregnating non-living materials, preferably textile materials, in particular nets.

In a fourth aspect of the invention, there is provided the use of such impregnated materials, in particular such impregnated textile materials, for protecting humans, animals and materials from harmful organisms.

Materials impregnated by the inventive process show an excellent pesticidal activity and wash fastness, while at the same time the process is simple and does not require the use of potentially harmful organic solvents.

The following details are relevant to the invention:

### Formulation

The formulation according to the present invention comprises at least a pesticide (A), a polymeric binder (B), water as the sole solvent component (C) and optionally further components (D).

### Pesticide (A)

The term “pesticide” as used herein comprises any kind of active ingredients suitable for combating harmful organisms, in particular insecticides, repellents, fungicides, molluscicide, and rodenticides.

The term “insecticides” as used herein comprises agents with arthropodicidal (specifically, insecticidal, acaricidal and miticidal) activity, if not otherwise stated in the context.

The term “fungicides” as used herein comprises agents with fungicidal, microbicidal and viricidal activity, if not otherwise stated in the context.

Preferably, the insecticide and/or repellent has a fast paralyzing or killing effect on the insect and low mammalian toxicity. Suitable insecticides and/or repellents are known to a person skilled in the art. Suitable insecticides and repellents are disclosed in E. C. Tomlin et al., The Pesticide Manual, 14 ed., The British Crop Protection Council, Farnham 2006, and the literature cited therein.

Preferred insecticides and/or repellents for carrying out the present invention include those disclosed in WO 2005/64072, page 11, line 28 to page 14, line 34 and in WO 2006/128870, page 12, line 1 to page 18, line 37.

Preference is given to insecticides from the following group:

I.1. Pyrethroids: allethrin, bifenthrin, cyfluthrin, cyhalothrin, cyphenothrin, cypermethrin, alpha-cypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin, profluthrin, dimefluthrin;

I.2. Carbamates: alanycarb, aldicarb, bendiocarb, benfuracarb, carbaryl, carbofuran, carbosulfan, fenoxycarb, furathiocarb, methiocarb, methomyl, oxamyl, pirimicarb, propoxur, thiodicarb, triazamate;

I.3. GABA antagonist compounds: acetoprole, endosulfan, ethiprole (III), fipronil (II), vaniliprole, pyrafluprole, pyriprole; phenylpyrazole compound of the formula (VI) (see below);

I.4. Growth regulators: a) chitin synthesis inhibitors: benzoylureas: chlorfluazuron, diflubenzuron, flucycloxuron, flufenoxuron, hexaflumuron, lufenuron, novaluron, noviflumuron, sulfluramid, teflubenzuron, teflumoron, buprofezin, diofenolan, hexythiazox, etoxazole, clofentazine; b) ecdysone antagonists: haliofenozide, methoxyfenozide, te- bufenozide, azadirachtin; c) juvenoids: pyriproxyfen, methoprene, fenoxycarb; d) lipid biosynthesis inhibitors: spirodiclofen, spiromesifen, spirotetramat;

I.5. Nicotin receptor agonist/antagonist compounds: acetamiprid, clothianidin, dinotefuran, imidacloprid, nitenpyram, thiacloprid, thiamethoxam;

I.6. Organo(thio)phosphates: acephate, azamethiphos, azinphos-methyl, chlorpyrifos, chlorpyrifos-methyl, chlorfenvinphos, diazinon, dichlorvos, dicrotophos, dimethoate, disulfoton, ethion, fenitrothion, fenthion, isofenphos, isoxathion, malathion, methamidophos, methidathion, methyl-parathion, mevinphos, monocrotophos, oxydemetonmethyl, paraoxon, parathion, phenthoate, phosalone, phosmet, phosphamidon, phorate, phoxim, pirimiphos-methyl, profenofos, prothiofos, sulprophos, tetrachlorvinphos, terbufos, tolazophos, trichlorfon;

I.7. Macrocyclic lactone insecticides: abamectin, emamectin, milbemectin, lepimectin, spinosad;

I.8. Site-I electron transport inhibitors: for example, fenazaquin, pyridaben, tebufenpyrad, tolfenpyrad;

I.9. Site-II and site-III electron transport inhibitors:

acequinocyl, fluacyprim, hydramethylnon (V);

I.10. Uncoupler compounds: chlorfenapyr (VI);

I.11. Oxidative phosphorylation inhibitor compounds: cyhexatin, diafenthiuron, fenbutatin oxide, propargite;

I.12. Chitin biosynthesis inhibitors:

cyromazine;

I.13. Mixed function oxidase inhibitor compounds:

piperonyl butoxide;

I.14. Sodium channel modulators:

indoxacarb, metaflumizone;

I.15. Active substances with unknown or nonspecific mechanisms of action:

benclothiaz, bifenazate, borate, cartap, chlorantraniliprole, flonicamid, pyddalyl, pymetrozine, sulfur, thiocyclam, flubendiamide, cyenopyrafen, cyflumetofen, flupyrazofos, amidoflumet.

The commercially available compounds of group I.1 to I.15 can be found in “The Pesticide Manual”, 14th edition, British Crop Protection Council, (2006). Lepimectin is known from “Agro Project”, PJB Publications Ltd, November 2004. Benclothiaz and its preparation are described in EP-A1 454621. Methidathion and paraoxon and their preparation are described in “Farm Chemicals Handbook”, volume 88, Meister Publishing Company, 2001. Acetoprole and its preparation are described in WO 98/28277. Flupyrazofos is described in “Pesticide Science” 54, 1988, pages 237-243 and in US 4822779. Pyrafluprole and its preparation are described in JP 2002193709 and in WO 01/00614. Pyriprole and its preparation are described in WO 98/45274 and in U.S. Pat. No. 6,335,357. Amidoflumet and its preparation are described in U.S. Pat. No. 6,221,890 and in JP 21010907. Flufenerim and its preparation are described in WO 3/007717 and in WO 03/007718. Cyflumetofen and its preparation are described in WO 04/080180.

A suitable molluscicide is for example niclosamide.

Examples of suitable rodenticides comprise those disclosed in WO 2005/64072, page 18, lines 9 to 14.

Examples of suitable fungicides comprise those disclosed in WO 2005/64072, page 15, line 13 to page 16, line 4.

Preferred fungicides are selected from the group consisting of

1. Strobilurins such as azoxystrobin, dimoxystrobin, enestroburin, fluoxastrobin, kresoxim-methyl, metominostrobin, picoxystrobin, pyraclostrobin, trifloxystrobin, orysastrobin, methyl (2-chloro-5-[1-(3-methylbenzyloxyimino)ethyl]benzyl)carbamate, methyl (2-chloro-5-[1-(6-methylpyridin-2-ylmethoxyimino)ethyl]benzyl)carbamate, methyl 2-(ortho-((2,5-dimethylphenyloxymethylene)phenyl)-3-methoxyacrylate;

2. Carboxamides such as carboxanilides: benalaxyl, benodanil, boscalid, carboxin, mepronil, fenfuram, fenhexamid, flutolanil, furametpyr, metalaxyl, ofurace, oxadixyl, oxycarboxin, penthiopyrad, thifluzamide, tiadinil, N-(4′-bromobiphenyl-2-yl)-4-difluoromethyl-2-methylthiazole-5-carboxamide, N-(4′-trifluoromethylbiphenyl-2-yl)-4-difluoromethyl-2-methylthiazole-5-carboxamide, N-(4′-ch loro-3′-fluorobiphenyl-2-yl)-4-difluoromethyl-2-methylthiazole-5-carboxamide, N-(3′,4′-dichloro-4-fluorobiphenyl-2-yl)-3-difluoromethyl-1-methylpyrazole-4-carboxamide, N-(2-cyanophenyl)-3,4-dichloro-isothiazole-5-carboxamide; carboxylic acid morpholides: dimethomorph, flumorph; benzamides: flumetover, fluopicolide (picobenzamid), zoxamide; other carboxamides: carpropamid, diclocymet, mandipropamid, N-(2-(4-[3-(4-chlorophenyl)prop-2-ynyloxy]-3-methoxyphenyl)ethyl)-2-methanesulfonylamino-3-methylbutyramide, N-(2-(4-[3-(4-chlorophenyl)prop-2-ynyloxy]-3-methoxyphenyl)ethyl)-2-ethanesulfonylamino-3-methyl-butyramide; N-(3′,4′-dichloro-5-fluorobiphenyl-2-yl)-3-difluoromethyl-1-methylpyrazole-4-carboxamide and 3-Difluoromethyl-1-methyl-1H-pyrazole-4-carboxylic acid (2-bicyclopropyl-2-yl-phenyl)-amide;

3. Azoles such as triazoles: bitertanol, bromuconazole, cyproconazole, difenoconazole, diniconazole, enilconazole, epoxiconazole, fenbuconazole, flusilazole, fluquinconazole, flutriafol, hexaconazole, imibenconazole, ipconazole, metconazole, myclobutanil, penconazole, propiconazole, prothioconazole, simeconazole, tebuconazole, tetraconazole, triadimenol, triadimefon, triticonazole; imidazoles: cyazofamid, imazalil, pefurazoate, prochloraz, triflumizole; benzimidazoles: benomyl, carbendazim, fuberidazole, thiabendazole; others: ethaboxam, etridiazole, hymexazole;

4. Nitrogenous heterocyclyl compounds such as pyridines: fluazinam, pyrifenox, 3-[5-(4-chlorophenyl)-2,3-dimethylisoxazolidin-3-yl]-pyridine; pyrimidines: bupirimate, cyprodinil, ferimzone, fenarimol, mepanipyrim, nuarimol, pyrimethanil; piperazines: triforine; pyrroles: fludioxonil, fenpiclonil; morpholines: aldimorph, dodemorph, fenpropimorph, tridemorph; dicarboximides: iprodione, procymidone, vinclozolin; others: acibenzolar-S-methyl, anilazine, captan, captafol, dazomet, diclomezine, fenoxanil, folpet, fenpropidin, famoxadone, fenamidone, octhilinone, probenazole, proquinazid, pyroquilon, quinoxyfen, tricyclazole, 5-chloro-7-(4-methylpiperidin-1-yI)-6-(2,4,6-trifluorophenyl)-[1,2,4]triazolo[1,5-a]pyrimidine, 2-butoxy-6-iodo-3-propylchromen-4-one, N,N-dimethyl-3-(3-bromo-6-fluoro-2-methylindole-1-sulfonyl)-[1,2,4]triazole-1-sulfonamide;

5. Carbamates and dithiocarbamates such as dithiocarbamates: ferbam, mancozeb, maneb, metiram, metam, propineb, thiram, zineb, ziram; carbamates: diethofencarb, flubenthiavalicarb, iprovalicarb, propamocarb, methyl 3-(4-chlorophenyl)-3-(2-isopropoxycarbonylamino-3-methylbutyrylamino)propionate, 4-fluorophenyl N-(1-(1-(4-cyanophenyl)ethanesulfonyl)but-2-yl)carbamate;

6. Other fungicides such as guanidines: dodine, iminoctadine, guazatine; antibiotics: kasugamycin, polyoxins, streptomycin, validamycin A; organometallic compounds: fentin salts; sulfur-containing heterocyclyl compounds: isoprothiolane, dithianon; organophosphorus compounds: edifenphos, fosetyl, fosetyl-aluminum, iprobenfos, pyrazophos, tolclofos-methyl, phosphorous acid and its salts; organochlorine compounds: thiophanate-methyl, chlorothalonil, dichlofluanid, tolylfluanid, flusulfamide, phthalide, hexachlorbenzene, pencycuron, quintozene; nitrophenyl derivatives: binapacryl, dinocap, dinobuton; inorganic active compounds: Bordeaux mixture, copper acetate, copper hydroxide, copper oxychloride, basic copper sulfate, sulfur; others: spiroxamine, cyflufenamid, cymoxanil and metrafenone.

Suitable pesticides may be selected by the skilled artisan depending in the intended use of the formulation or more specifically the intended use of the non-living material to be treated with the formulation. Only one pesticide may be used, but it is of course possible to use a mixture of two or more different pesticides.

Preferred insecticides and/or repellents are selected from the group of synthetic pyrethroids such as alphacypermethrin, cyfluthrin, deltamethrin, ethofenprox and permethrin, other pyrethroids such as bifenthrine and non-pyrethroids such as carbosulphanes, pyrrole insecticides, such as chlorfenapyr, and pyrazole insecticides, such as fipronil. If insecticides and repellents are chiral substances, they may be applied as racemates, pure enantiomers or diastereomers or in chirally enriched mixtures. Most preferred are alphacypermethrin, chlorfenapyr and fipronil.

Only one pesticide moiety may be used, but also mixtures of two or more different pesticides. Preferred are mixtures of the above referenced pyrethroids with one or more insecticides from other classes, specifically with other pyrrole or pyrazole insecticides, such as chlorfenapyr and fipronil. Mixtures of alphacypermethrin with other insecticides, in particular with chlorfenapyr, are particularly preferred. Further particularly preferred are mixtures of alpha cypermethrin with a synergist, in particular piperonyl butoxide. The weight ratio of pyrethroid / insecticidal mixing partner is generally in the range of from 10:1-1:10.

Due to the requirement that the formulation must not contain an organic solvent the insecticide is added either as the technical active ingredient (a.i.), or as an organic solvent free formulation, such as a SC (suspension concentrate), WG (water dispersible granules) or WP (wettable powder) formulation.

Polymeric binder (B)

The aqueous formulation, which is free of organic solvents, furthermore comprises at least one polymeric binder (B) dispersed in the formulation which comprises one or more fluorinated acrylic copolymers useful in the water and oil resistant formulations of the present invention include copolymer prepared by the polymerization of a perfluoroalkyl acrylate monomer of formula (I) and a comonomer, especially an acrylate monomer of formula (II):

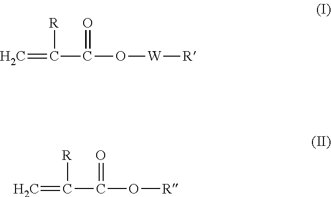

wherein R is hydrogen or a lower alkyl of 1 to 4 carbon atoms, W is an alkylene of 1 to 6 carbon atoms, R′ is a perfluoroalkyl of 2 to 20 carbon atoms and R″ is lower alkyl of 1 to 6 carbon atoms, hydroxyalkylene of 2 to 4 carbon atoms or the group —(CH₂)ₙ—NH—R′″ in which R″′ is lower alkyl of 1 to 6 carbon atoms or cycloalkyl an n is an integer of 2 to 4.

The term “alkyl” includes straight and branched chain alkyl groups.

The term “cycloalkyl” means a cycloalkyl hydrocarbon of 4 to 8 carbon atoms.

The fluorinated acrylic copolymers can be prepared by polymerization such as emulsion polymerization using standard procedures such as described in U.S. Pat. Nos. 4,478,975 and 4,778,915, the disclosures of which are incorporated herein by reference. The copolymers are prepared using about 1 to 30% of a monomer of formula II, more usually 1 to 10%, based on the total weight of monomers I and II.

The amount of fluorinated acrylic copolymer included in the formulation (=impregnation solution) of the invention may vary from one formulation to the next. The most effective amount of fluorinated acrylic copolymer can be easily determined by routine testing. Generally, the fluorinated acrylic copolymer will be present in the liquid formulation within the range of about 0.05 to 20% by weight of the total formulation, more usually, 0.1 to 10%.

The fluorine content of the polymeric binder (B) is at least 10 wt.-%, preferably at least 15 wt.-%, in particular at least 20 wt.% (based on the solid content of the polymeric binder (B) with the upper limit being generally 60 wt.-%, preferably 55 wt.-%, and in particular 50 wt.-%.

The polymeric binder is generally employed as an aqueous dispersion that is free of organic solvents.

Commercial products containing fluorinated acrylic copolymer include Lurotex® TX R and Lurotex® TX S (both from BASF SE, Ludwigshafen, Germany), Evo Protect® FCS, Pluvioperl® 9256 and Evo Guard® FSU (all three from Dystar Textilfarben GmbH, Frankfurt am Main, Germany), and Ruco Guard® Air (Rudolf GmbH, Geretsried, Germany).

The weight ratio of polymeric binder (B) (solid content) and insecticide is generally in the range of from 1:0.1-1:20, preferably of from 1:0.2-1:5.

### Solvent Component (C)

Only water is used as solvent for the formulation. However, trace amounts of organic solvents miscible with water may be present. Examples of solvents comprise watermiscible alcohols, e.g. monoalcohols such as methanol, ethanol or propanol, higher alcohols such as ethylene glycol or polyether polyols and ether alcohols such as butyl glycol or methoxypropanol. Preferably the content of an organic solvent is no more than 5% by weight (based on component (C), more preferably no more than 1% by weight (based on component (C), in particular no more than 0.1% by weight, based on component (C).

### Additional Components (D)

Depending on the intended use of the non-living material to be treated the formulation according to the present invention may further comprise one or more components selected from preservatives, detergents, fillers, impact modifiers, anti-fogging agents, blowing agents, clarifiers, nucleating agents, coupling agents, fixative agents, cross-linking agents, conductivity-enhancing agents (antistats), stabilizers such as antioxidants, carbon and oxygen radical scavengers and peroxide decomposing agents and the like, flame retardants, mould release agents, agents having UV protecting properties, spreading agents, anti-blocking agents, anti-migrating agents, foam-forming agents, anti-soiling agents, thickeners, further biocides, wetting agents, plasticizers and film-forming agents, adhesive or anti-adhesive agents, optical brightening (fluorescent whitening) agents, pigments and dyestuffs.

In one preferred embodiment, the formulation according to the invention furthermore comprises at least one pigment and/or at least one dyestuff.

Surfactants may be used for stabilizing the pesticide (A) and/or the polymeric binder (B) in the formulation. In particular preferred are anionic and/or non-ionic surfactants. Typical examples shave already been mentioned above.

Suitable fixative agents are for example isocyanates or isocyanurates comprising free isocyanate groups. Preferably the isocyanurates are based on alkylene diisocyanates having from 4 to 12 carbon atoms in the alkylene unit, like 1,12-dodecane diisocyanate, 2-ethyltetramethylene diisocyanate-1,4, 2-methylpentamethylene diisocyanate-1,5, tetramethylene diisocyanate-1,4, lysinester diisocyanate (LDI), hexamethylene diisocyanate-1,6 (HMDI), cyclohexane-1,3-and/or-1,4-diisocyanate, 2,4-and 2,6-hexahydrotoluylene diisocyanate as well as the corresponding isomeric mixtures 4,4′-2,2′- and 2,4′-dicyclohexylmethane diisocyanate as well as the corresponding mixtures, 1-isocyanato-3,3,5-trimethyl-5-isocyanatomethyl cyclohexane (IPDI), 2,4- and/or 2,6-toluylene diisocyanate, 4,4′-, 2,4′ and/or 2,2′-diphenylmethane diisocyanate (monomeric MDI), polyphenylpolymethylene polyisocyanate (polymeric MDI) and/or mixtures comprising at least 2 of the isocyanates mentioned before. More preferably the isocyanurates are based on hexamethylene diisocyanate-1,6 (HMDI).

Also preferred the isocyanurate is a isocyanurate which is hydrophilized with a polyalkylene oxide based on ethylene oxide and/or 1,2-propylene oxide, preferably polyethylene oxide.

Suitable anti-foam agents are for example silicon anti-foam agents. Suitable UV-protecting agents for protecting UV-sensitive pesticides are for example para-aminobenzoic acids (PABA), octylmethoxysinameth, stilbenes, styryl or benzotriazole derivatives, benzoxazol derivatives, hydroxy-substituted benzophenones, salicylates, substituted triazines, cinnamic acid derivatives (optionally substituted by 2-cyano groups), pyrazoline derivatives, 1,1′-biphenyl-4,4′-bis-2-(methoxyphenyl)-ethenyl or other UV protecting agents. Suitable optical brighteners are dihydroquinolinone derivatives, 1,3-diaryl pyrazoline derivatives, pyrenes, naphthalic acid imides, 4,4′- diystyryl biphenylene, 4,4′-diamino-2,2′-stilbene disulphonic acids, cumarin derivatives and benzoxazole, benzisoxazole or benzimidazole systems which are linked by —CH═CH-bridges or other fluorescent whitening agents.

Typical pigments which may be used in the formulation according to the present invention are pigments which are used in pigment dyeing or printing processes or are applied for the coloration of plastics.

Pigments may be inorganic or organic by their chemical nature. Inorganic pigments are mainly used as white pigments (e.g., titanium dioxide in the form of rutile or anatas, ZnO, chalk) or black pigments (e.g., carbon black). Colored inorganic pigments may be used as well but are not preferred because of potential toxicologic hazards. For imparting color, organic pigments or dyestuffs are preferred. Organic pigments may be mono or disazo, naphthol, benzimidazolone, (thio) indigoid, dioxazine, quinacridone, phthalocyanine, isoindolinone, perylene, perinone, metal complex or diketo pyrrolo pyrrole type pigments. Pigments may be used in powder or liquid form (i.e., as a dispersion). Preferred pigments are Pigment Yellow 83, Pigment Yellow 138, Pigment Orange 34, Pigment Red 170, Pigment Red 146, Pigment Violet 19, Pigment Violet 23, Pigment Blue 15/1, Pigment Blue 15/3, Pigment Green 7, Pigment Black 7. Other suitable pigments are known to a person skilled in the art.

Typical dyestuffs which may be used in the present invention are vat dyes, cationic dyes and disperse dyes in powder or liquid form. Using the vat pigment form is preferred. Vat dyes may be of the indanthrone type, e.g. C.I. Vat Blue 4, 6 or 14; or of the flavanthrone type, e.g. C.I. Vat Yellow 1; or of the pyranthrone type, e.g. C.I. Vat Orange 2 and 9; or of the isobenzanthrone (isoviolanthrone) type, e.g. C.I. Vat Violet 1; or of the dibenzanthrone (violanthrone) type, e.g. C.I. Vat Blue 16, 19, 20 and 22, C.I. Vat Green 1, 2 and 9, C.I. Vat Black 9; or of the anthraquinone carbazole type, e.g. C.I. Vat Orange 11 and 15, C.I. Vat Brown 1, 3 and 44, C.I. Vat Green 8 and C.I. Vat Black 27; or of the benzanthrone acridone type, e.g. C.I. Vat Green 3 and 13 and C.I. Vat Black 25; or of the anthraquinone oxazole type, e.g. C.I. Vat Red 10; or of the perylene tetra carbonic acid diimide type, e.g. C.I. Vat Red 23 and 32; or imidazole derivatives, e.g. C.I. Vat Yellow 46; or amino triazine derivatives, e.g. C.I. Vat Blue 66. Other suitable vat dyes are known to a person skilled in the art. Typical disperse and cationic dye-stuffs are known to the person skilled in the art.

### Manufacture of the Formulation

The formulation according to the invention may be formed by mixing all ingredients together with water optionally using suitable mixing and/or dispersing aggregates. In general, the formulation is formed at a temperature of from 10 to 70° C., preferably 15 to 50° C., more preferably 20 to 40° C.

It is possible to use solid pesticide (A), solid polymer (B) and optionally additional additives (D) and to disperse them in the aqueous component (C)

However, it is preferred to use dispersions of the polymeric binder (B) in water as well as aqueous formulations of the pesticide (A) in water which have been separately prepared before. Such separate formulations may contain additional additives for stabilizing (A) and/or (B) in the respective formulations and are commercially available. In a second process step, such raw formulations and optionally additional water (component (C)) are added.

Also combinations are possible, i.e. using a pre-formed dispersion of (A) and/or (B) and mixing it with solid (A) and/or (B).

A dispersion of the polymeric binder (B) may be a pre-manufactured dispersion already made by a chemicals manufacturer.

However, it is also within the scope of the present invention to use “hand-made” dispersions, i.e. dispersions made in small-scale by an end-user. Such dispersions may be made by providing a mixture of about 20% of the binder (B) in water, heating the mixture to temperature of 90 to 100° C. and intensively stirring the mixture for several hours.

It is possible to manufacture the formulation as a final product so that it can be readily used by the end-user for the process according to the present invention.

However, it is of course also possible to manufacture a concentrate, which may be diluted by the end-user with additional water (C) to the desired concentration for use.

Furthermore, it may be possible to ship the formulation to the end-user as a kit comprising at least
a first component comprising at least one pesticide (A); and
a second component comprising at least one polymeric binder (B).

Further additives (D) may be a third separate component of the kit, or may be already mixed with components (A) and/or (B).

The end-user may prepare the formulation for use by just adding water (C) to the components of the kit and mixing.

The components of the kit may be in form of a dry composition such as a powder, a capsule, a tablet, or an effervescent tablet. Suitable pesticides in dry form are available as effervescent tablets or wettable powders which can be easily dissolved to a homogeneous formulation by manual stirring or shaking.

The components of the kit may be formulations in water.

Of course it is possible to combine an aqueous formulation of one of the components with a dry formulation of the other component(s).

In a preferred embodiment of the invention the kit comprises
one formulation of the pesticide (A) and optionally water (C); and
a second, separate formulation of at least one polymeric binder (B), water as component (C) and optionally components (D).

### Concentrations of the Components

The concentrations of the components (A), (B), (C) and optionally (D) will be selected by the skilled artisan depending of the technique to be used for impregnation.

In general, the amount of pesticide (A) may be up to 80% by weight, preferably 5 to 50% based on the amount of all components (A), (B) and (D) together, i.e. all components except the aqueous solvent (C).

The amount of polymeric binder (B) may be in the range of 10 to 90% based on the amount of all components (A), (B) and (D) together.

If present, in general the amount of additional components (D) is from 0,1 to 40%, preferably 0.5% to 35% based on the amount of (A), (B), and (C) together. If present, suitable amounts of pigments and/or dyestuffs are in general 0.01 to 20% by weight, preferably 0.1 to 10% by weight, more preferably 0.2 to 5% by weight, based (A), (B), and (D).

A typical formulation ready for use in impregnation processes comprises 0.01 to 10%, preferably 0.1 to 5% of components (A), (B), and optionally (D), the residual amount being water (C).

A typical concentration of a concentrate to be diluted by the end-user may comprise 5 to 50% of components (A), (B), and optionally (D), the residual amount being water (C).

### Method of Impregnation

The aim of the invention is to control a variety of pests, such as mosquitoes, ticks, cockroaches, mites, fleas, lice, leeches, houseflies, and other flying and crawling insects by treatment of non-living materials with pesticides and polymeric binders.

The polymeric binder binds the pesticides preferably to the surface of such non-living materials and ensures a long-term effect. Using the binder reduces the elimination of the pesticide out of the non-living materials due to environmental effects such as rain or due to human impact on the non-living material such as washing and/or cleaning it.

The non-living material may be any kind of non-living material. Examples include buildings, leather, synthetic adaptions of leather, flocked fabrics, sheets, foils and packaging material, wood, wall linings and coatings, carpets.

Preferably, the non-living material is a textile material. The term “textile materials” shall include but not be limited to fibers, yarns, wovens, nonwovens, formed-loop knits, drawn-loop knits.

In a further preferred embodiment of the invention, the textile material is a fabric material and in particular a netting. The fabric material or the netting may be made of a variety of natural and synthetic fibers, also as textile blends in woven or non-woven form, as knit goods or fibers. Natural fibers are for example cotton, wool, silk, jute or hemp. Synthetic fibers may be made of polyamides, polyesters, polyacrylonitriles, polyolefines, for example polypropylene or polyethylene, Teflon, and mixtures of fibers, for example mixtures of synthetic and natural fibers. Polyamides, polyolefins and polyesters are preferred as fiber material. Polyethylene terephthalate is especially preferred. Most preferred are nettings made from polyester, especially polyethylene terephthalate.

The fabric material may be in form of coverings, for example mattresses, pillows, duvets, cushions, curtains, wall coverings, wall linings and window and door screens.

Further typical fabric materials are tents, mats, garments, such as socks, trousers, shirts, i.e. preferably garments used in body areas exposed to insecticide bites and the like. The nettings are for example used as bed nets for example mosquito nets, or for covering. Other applications are movable fences for the protection of humans and animals against air-borne low-flying insects. Fabrics or nettings may be used for wrapping sacks, containers of food and feed thus protecting the material from attack by insects but avoiding direct contact with the insecticide-treated nets or fabrics. Treated foils or tarpaulins can be used on all human premises which are permanently or temporarily inhabited such as refugee camps.

The process of the invention is particularly suitable for the impregnation of polyester nettings for use as mosquito nets.

The method of impregnation is not limited to a specific technology of treatment. Impregnation may be performed by dipping or submerging the non-living-material into the formulation or by spraying the formulation onto the surface of the non-living-material. After treating the treated non-living material may be dried simply at ambient temperatures. Dispersing or submerging the non-living material are preferred impregnation methods.

The polymeric binder (B) used in the method according to the present invention does not require drying at higher temperatures, crosslinking or other aftertreatment steps, though it is of course within the scope of this invention to perform such additional steps. Even after drying at ambient temperatures, the binder (B) provides a sufficient binding of the pesticide to the surface of the non-living-material. In preferred embodiments of the invention no drying at temperatures above 60° C., crosslinking or aftertreatment takes place.

Accordingly, no sophisticated technology is necessary for impregnation, and therefore the impregnation process may be carried out by the end-user itself in at low-scale. For instance, a typical end-user may impregnate a mosquito-net itself, e.g. within its household, using the formulation according to the present invention. For this purpose, it is in particular advantageous to use the impregnation-kit according to the present invention.

The formulation of the present invention may be applied to fabric materials or nettings before their formation into the required products, i.e. while still a yarn or in sheet form, or after formation of the relevant products.

For the case of fabrics and/or nettings, in a preferred embodiment, the present invention relates to a process for impregnation of fabrics and/or netting materials at least comprising the following steps:

a) treating the fabric and/or netting with the aqueous formulation according to the invention by any of the procedural steps selected from the group of
(a1) passing the fabric material or netting through the formulation; or
(a2) contacting the fabric material or netting with a roller that is partly or fully dipped into the formulation and drawing the formulation to the side of the netting of fabric material in contact with the roller, or
(a3) submerging the material into the formulation; or
(a4) spraying the formulation onto the fabric material or netting; or
(a5) brushing the formulation onto or into the fabric material or netting; or
(a6) applying the formulation as a foam; or
(a7) coating the formulation onto fabric material or netting.

b) optionally removing surplus formulation by squeezing the material between rollers or by means of a doctor blade; and
c) drying the fabric material or netting.

In case the raw materials containing residues of preceding production processes, e.g. sizes, spin finishes, other auxiliaries and/or impurities, it may be beneficial to perform a washing step before the impregnation.

Specifically, the following details are important for the steps a), b), and c).

Step a1)

The formulation is applied by passing the fabric or netting through the aqueous formulation. Said step is known by a person skilled in the art as padding. In a preferred embodiment the fabric or netting is completely submerged in the aqueous formulation either in a trough containing the liquor or the fabric or netting is passed through the formulation which is held between two horizontally oriented rollers. In accordance with the invention, the fabric material or netting may either be passed through the formulation or the formulation may be passed through the fabric or netting. The amount of uptake of the formulation will be influenced by the stability of concentrated baths, the need for level distribution, the density of fabric or netting and the wish to save energy costs for drying and curing steps. Usual liquor-uptakes may be 40 to 150% on the weight of material. A person skilled in the art is familiar with determining the optimum value. Step al) is preferred for impregnating open-width material which is later tailored into nets.

For small-scale production or re-impregnating of non-treated nets, use of a simple hand-held roller may be sufficient.

Step a2)

It is further possible to apply the aqueous formulation on the fabric material or netting by a roller that is partly dipped into the dispersion thus applying the dispersion to the side of the fabric material or netting in contact with the roller (kiss-rolling). By this method it is possible to impregnate only one side of the fabric material or netting which is advantageous if e.g. direct contact of the human skin with insecticide-treated material is to be avoided.

Impregnation of the fabric material or netting in step al), a2) or a3) is typically carried out at temperatures from 10 to 70° C., preferably 15 to 50° C., more preferably 20 to 40° C.

Step a4)

The spray may be applied in continuous processes or in batch-wise processes in suitable textile machines equipped with a spraying device, e.g. in open-pocket garment washer/extractors. Such equipment is especially suitable for impregnating ready-made nets.

Step a6)

A foam comprises less water than the dispersion mentioned above. The drying process may therefore be very short. The treatment may be performed by injecting gas or blends of gas (e.g., air) into it. The addition of surfactants, preferably with film-forming properties, may be required. Suitable surfactants and the required technical equipment are known to persons skilled in the art.

Step a7)

A coating process may preferably carried out in a doctor-blade process. The process conditions are known to a person skilled in the art.

### Step b)

The surplus emulsion is usually removed by squeezing the fabric or netting, preferably by passing the fabric material or netting through rollers as known in the art thus achieving a defined liquor uptake. The squeezed-off liquor may be re-used. Alternatively, the surplus aqueous emulsion or aqueous dispersion may be removed by centrifuging or vacuum suction.

### Step c)

Drying may be performed at ambient temperatures. In particular, such a passive drying may be carried out in hot-dry climate. Of course, the drying process may be accelerated applying elevated temperatures. An active drying process would normally be performed during high scale processing. The drying is in general carried out temperatures below 200° C. Preferred temperatures are from 30 to 170° C., more preferably at room temperature. The temperature choice is determined by the thermal stability of the insecticide in the formulation and the thermal stability of the non-living material impregnated.

For the method according to the invention aqueous formulation comprising at least one pigment and/or at least one dyestuff may be used so that the fabric material or netting is not only impregnated with the pesticide but in addition also coloured at the same time.

The process disclosed yields in an impregnated non-living-material. Therefore, in a further embodiment the present invention relates to an impregnated non-living material obtainable by the inventive process and comprising at least one pesticide (A) and at least on polymeric binder (B).

Preferably, the non-living-material is a netting or fabric material, and preferably the pesticide (A) is an insecticide and/or repellant. Preferred insecticides and/or repellents, polymeric binders (B) and preferred materials for the netting or fabric materials have already been mentioned.

A typical amount of insecticide and/or repellent in the impregnated netting or fabric is from 0.01 to 10% (dry weight) of the (dry) weight of the fabric material or netting dependent on the insecticidal efficiency of the insecticide respectively the efficiency of the repellent. A preferred amount is between 0.05 and 5% by weight of the fabric material or netting depending on the insecticide and/or repellent. For a pyrethroid like deltamethrin or alphacypermethrin, the preferred amounts are between 0.08 and 3.5% of the weight of the fabric or netting. For a pyrethroid like permethrin or ethofenprox, the preferred amount is from 0.1 to 6%.

A typical amount of the polymeric binder (B) is from 0.01 to 10% by weight (dry weight) of the (dry) weight of the fabric or netting. As a general guideline, the weight ratio between insecticide and binder (B) should approximately be constant with a value depending on the insecticidal and migratory ability of the insecticide, i.e. the higher the amount the insecticide the higher also the amount of binder (B). Preferred amounts of binder (B) are from 0.1 to 5% by weight, more preferably 0.2 to 3% by weight of the (dry) weight of the fabric or netting.

Preferably, the impregnated fabric or netting comprises at least one pigment and/or at least one dyestuff. The amount of the at least one pigment and/or dyestuff is in general from 0.05 to 10% by weight, preferably 0.1 to 5% by weight, more preferably 0.2 to 3.5% by weight of the (dry) weight of the fabric material or netting.

The impregnated fabric or netting materials may be used for various purposes.

In particular, such impregnated fabric or netting materials may be used for the protection men, animals and/or materials from harmful organisms. For instance, they may be used as mosquito-nets. Mosquito-nets impregnated according to the present invention may be washed several times without significant decrease in insect-controlling activity.

For the protection of materials or objects, like buildings and premises (houses, streets) from harmful organisms, they may be wrapped around the material or object to be protected or the materials or objects to be protected may be covered with it.

Examples of materials to be protected comprise crops and/or harvested crops such as e.g. tobacco, tobacco bales or other tobacco products which may be protected from harmful organisms during harvesting, drying, curing, transport and storage. The method according to the present invention avoids the necessity to treat such crops to be protected directly with pesticides or other chemicals.

Furthermore, the nets may be used for protecting animals in corrals and stables from insects and other pests.

### EXAMPLES

### Materials Used

### Nettings

Commercial netting material made from PET (polyethylene terephthalate) fibers, complying with WHO-Roll Back Malaria “Specifications for netting materials” (Geneva, 2001) was used.

### Example 1

### Dipping Technique

### Formulation Comprising a Binder According to the Invention

### Impregnation of the Nettings

A mixture of 0.4 g (solids content) binder, 1.2 g of an alphacypermethrin SC (9.4% a. i.) in 100 ml water was manufactured as impregnating solution. 4.7 ml of this mixture were added to 0.14 m² of a 75 Dernier polyester netting. The netting treated in such a manner was dried for 24 hours at 20° C.

Theoretical concentration of active ingredient (alphacypermethrin): 40 mg/m²=1.36 mg/g (found by GC analysis: 1.41 mg/g).

As binders were used (Examples):

Ex. 1-1: Lurotex® TX R (BASF, solids content: 18.5%, F-content: >10%)

Ex. 1-2: Lurotex® TX S (BASF, solids content: 25.5%, F-content: >10%)

Ex. 1-3: Evo Protect® FCS (Dystar, solids content: 20.0%, F-content: >10%)

Ex. 1-4: Pluvioperl® 9256 (Dystar, solids content: 31.5%, F-content: >10%)

Ex. 1-5: Evo Guard® FSU (Dystar, solids content: 22.0%, F-content: >10%)

Ex. 1-6: Ruco-Guard® Air (Rudolf, solids content: 18.5%, F-content: >10%)

### Comparative Examples

C. 1-1: Without binder

C. 1-2: Helizarin TOW (BASF, solids content: 40.0%, F-content 0%)

C. 1-3: Smart Protect P1000 (BASF, solids content: 38.0%, F-content <10.0%)

### Testing Method

“Montpellier washing procedure” (as described in the annex World Health Organization PVC, Mar. 7, 2002 “Evaluation of wash resistance of long-lasting insecticidal nets”): Net samples were washed individually in beakers containing 0.5 L deionised water and 2 g/L soap (pH 10-11) at 30° C. in a water bath shaken for 10 minutes at 155 movements per minute.

Since there are no industry norms for washing procedures mimicking hand washes, we adapted a standard laundry process by using the IEC detergent test formulation (which contains anionic, non-ionic detergents, zeolithes, inorganic builder but omitting the bleaching system) for 30 min at 60° C. in metal vessels which are moved (tumbled) and heated. This method imparts more severe conditions than the hand wash relative to temperature, emulsifying and dispersing effects but exerts probably less friction on the nets.

Testing procedure: Two bioassays were used with 4 replicate tests done on each piece: the 3 min bioassay in which there is forced contact of laboratory-reared Anopheles mosquitoes with treated netting for 3 min and 24-h holding period before scoring mortality (as “% mortality”).

The long-established standard for ITN testing is with the use of WHO cones (WHOPES 96.1): clear plastic cone structures (1.1 cm diameter) with a flat flange around the bottom edge and a hole at the apex. The general procedure is to secure the cone to treated netting, flange side to the net, and introduce 5 mosquitoes into the cone and the hole plugged with cotton or a stopper. For inherent insecticidal activity, the insects are left in the cone resting on the netting for three minutes and then removed to a holding container supplied with sugar water. Mosquitoes from four cones are pooled to give 20 or more insects per holding container. Knockdown (KD) data can then be collected from the pooled mosquitoes at predetermined times out to 24-hours. For speed of knockdown, the mosquito can be left in the cone and the time to KD recorded for each individual mosquito until the 6^{th} of 11 insects (median) goes down. Each KD mosquito is removed as it goes down to prevent recounting that insect if it once again flies. All mosquitoes are then held as described previously for a 24-hour KD count. All results are summarized in table 1.

TABLE 1

| | Treatment | | | | | |
|---|---|---|---|---|---|---|
| | 5 washes | | 10 washes | | 15 washes | |
| Example | % KD | % Mort | % KD | % Mort | % KD | % Mort |
| 1-1 | 92 | 82 | 94 | 94 | 98 | 82 |
| 1-2 | 84 | 98 | 90 | 68 | 84 | 80 |
| 1-3 | 100 | 100 | 56 | 88 | 86 | 88 |
| 1-4 | 98 | 100 | 96 | 92 | 56 | 34 |
| 1-5 | 100 | 100 | 100 | 98 | 100 | 94 |
| 1-6 | 94 | 76 | 92 | 70 | 100 | 92 |
| C 1-1 | 78 | 46 | 58 | 50 | 6 | 2 |
| C 1-2 | 30 | 6 | 30 | 36 | 44 | 56 |
| C 1-3 | 82 | 74 | 80 | 66 | 70 | 50 |

KD = Knockdown
Mort. = Mortality

1-15. (canceled)

16. A process for manufacturing a pesticide treated non-living material comprising the step of impregnating the non-living material with an aqueous formulation free of organic solvents which comprises one or more pesticides (A), a polymeric binder (B) comprising one or more fluorinated acrylic copolymer having a fluorine content, based on the solid content of the polymeric binder, of at least 10% by weight, and water as the sole solvent component (C),
wherein the insecticide is selected from the group consisting of alphacypermethrin, cyfluthrin, deltamethrin, ethofenprox, bifenthrine, carbosulphane, chlorfenapyr and fipronil, and wherein the fluorinated acrylic copolymer is prepared by the polymerization of a perfluoroalkyl acrylate monomer of the formula (I) and a co-monomer, which is an acrylate monomer of formula (II) 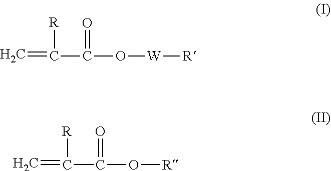
wherein R is hydrogen or a lower alkyl of 1 to 4 carbon atoms, W is an alkylene of 1 to 6 carbon atoms, R′ is a perfluoroalkyl of 2 to 20 carbon atoms and R″ is lower alkyl of 1 to 6 carbon atoms, hydroxyalkylene of 2 to 4 carbon atoms or the group —(CH₂)ₙ—NH—R″′ in which R″′ is lower alkyl of 1 to 6 carbon atoms or cycloalkyl and n is an integer of 2 to 4.

17. The process according to claim 16, wherein the amount of fluorine in the polymeric binder is at least 20 wt.-% and at most 60 wt.-%.

18. The process according to claim 16, wherein the pesticide (A) is selected from the group consisting of alphacypermethrin, chlorfenapyr and fipronil.

19. The process according to claim 16, wherein a mixture of at least two different pesticides is used.

20. The process according to claim 16, wherein the formulation comprises additionally auxiliary components (D), selected from the group consisting of preservatives, detergents, fillers, impact modifiers, anti-fogging agents, blowing agents, clarifiers, nucleating agents, coupling agents, conductivity-enhancing agents, anti-oxidants, flame retardants, mould release agents, agents having UV protecting properties, spreading agents, anti-blocking agents, anti-migrating agents, foam-forming agents, anti-soiling agents, thickeners, biocides, wetting agents, plasticizers, film-forming agents, adhesive or anti-adhesive agents, optical brightening agents, pigments and dyestuffs.

21. The process according to claim 16, wherein the weight ratio of (A) to (B) is from 1:0.1 to 1:20.

22. The process according to claim 16, wherein the non-living-material is a textile material.

23. The process according to claim 16, comprising the further step of drying the impregnated non-living-material at ambient temperatures.

24. The process according to of claim 16, wherein the non-living material is a building, wall lining or coating.

25. An aqueous formulation free of organic solvents, comprising one or more pesticides (A), a polymeric binder (B) comprising one or more fluorinated acrylic copolymer having a fluorine content, based on the solid content of the polymeric binder, of at least 10% by weight, and water as the sole solvent component (C),
wherein the insecticide is selected from the group consisting of alphacypermethrin, cyfluthrin, deltamethrin, ethofenprox, bifenthrine, carbosulphane, chlorfenapyr and fipronil,
and wherein the fluorinated acrylic copolymer is prepared by the polymerization of a perfluoroalkyl acrylate monomer of the formula (I) and a co-monomer, which is an acrylate monomer of formula (II) 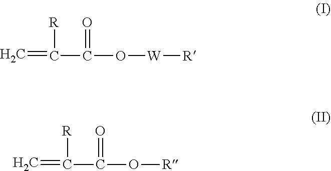
wherein R is hydrogen or a lower alkyl of 1 to 4 carbon atoms, W is an alkylene of 1 to 6 carbon atoms, R′ is a perfluoroalkyl of 2 to 20 carbon atoms and R″ is lower alkyl of 1 to 6 carbon atoms, hydroxyalkylene of 2 to 4 carbon atoms or the group —(CH₂)ₙ—NH—R′″ in which R′″ is lower alkyl of 1 to 6 carbon atoms or cycloalkyl and n is an integer of 2 to 4.

26. The formulation of claim 25, wherein the amount of fluorine in the polymeric binder is at least 20 wt.-% and at most 60 wt.-%.

27. The formulation of claim 25, wherein the pesticide (A) is selected from the group consisting of alphacypermethrin, chlorfenapyr and fipronil.

28. The formulation of claim 25, comprising a mixture of at least two different pesticides is used.

29. The formulation of claim 25, wherein the formulation comprises additionally auxiliary components (D), selected from the group consisting of preservatives, detergents, fillers, impact modifiers, anti-fogging agents, blowing agents, clarifiers, nucleating agents, coupling agents, conductivity-enhancing agents, anti-oxidants, flame retardants, mould release agents, agents having UV protecting properties, spreading agents, anti-blocking agents, anti-migrating agents, foam-forming agents, anti-soiling agents, thickeners, biocides, wetting agents, plasticizers, film-forming agents, adhesive or anti-adhesive agents, optical brightening agents, pigments and dyestuffs.

30. The formulation of claim 25, wherein the weight ratio of (A) to (B) is from 1:0.1 to 1:20.
